(19) United States
(12) Patent Application Publication
(10) Pub. No.: US 2010/0059466 A1
(43) Pub. Date: Mar. 11, 2010

(54) Storage System and Locking System Therefor

(76) Inventors: Jeff Tanner, Temecula, CA (US); Michael Cranfill, Saginaw, TX (US); Greg Smith, Indianapolis, IN (US); Roger Wiley, Granbury, TX (US); Doug Brown, Madison, IN (US)

Correspondence Address: LAW OFFICES OF JAMES E. WALTON, PLLC, 1169 N. BURLESON BLVD., SUITE 107-328, BURLESON, TX, 76028, US

(21) Appl. No.: 12/593,129

(22) PCT Filed: Mar. 27, 2008
(86) PCT No.: PCT/US08/58419

§ 371 Date: Sep. 25, 2009

Related U.S. Application Data
(60) Provisional application No. 60/920,448, filed on Mar. 28, 2007.
(60) Provisional application No. 60/931,365, filed on May 23, 2007.

(51) Int. Cl. A47F 5/00; E05B 65/00

(52) U.S. Cl. 211/134; 70/174

(57) ABSTRACT

A storage system comprises a support assembly, a shelf assembly supported by the support assembly, and a drive system controllable by a user to raise and lower the shelf assembly. The shelf assembly includes a storage platform and panels that are removable from the storage platform. In some embodiments, the size of the storage platform is adjustable. In some embodiments, a single-point locking system is employed that includes a cam for engaging a sliding carriage that moves as the platform rises and lowers. A cam spring urges the cam towards a locking position, where the cam prevents the sliding carriage from moving in a platform-lowering direction.

### TECHNICAL FIELD

The technical field is storage systems and methods providing for adjustable storage systems and locking systems for storage systems.

### DESCRIPTION OF RELATED ART

Storage units and garages typically house stored items that are stacked or scattered about the floor. In some cases fixed shelving is provided to allow for some amount of elevated storage. However, storing items on shelves requires lifting the items onto the shelves, and if the items are heavy this process can be labor intensive. There is also a risk of injury if proper safety equipment and lifting techniques are not employed. In the case of extremely heavy items, it may be necessary to use a forklift in order to store the items on a shelf.

If the shelves are very high, then reaching the shelves becomes a problem, so a ladder or the like must be used in order to place items on the shelves. The use of a ladder presents additional risks. For example, if heavy items are being placed on the shelves, it can be easy for one to lose their balance while climbing the ladder and suffer a fall that can result in injury or damage to property. Also, constantly climbing up and down the ladder to store the items increases the amount of time it takes to get a number of items stored on the shelves.

It would be desirable, therefore, to provide an improved method for storage that alleviates difficulties associated with these shortcomings of the prior art.

### BRIEF DESCRIPTION OF THE DRAWINGS

FIG. 1 shows a perspective view of a first embodiment of a storage system according to the present disclosure

FIG. 2 shows a side view of the storage system shown in FIG. 1.

FIG. 3 shows a perspective view of a second embodiment of the storage system according to the present disclosure.

FIG. 4 shows a partial view of the second embodiment of the storage system shown in FIG. 3.

FIG. 5 shows a second perspective view of the second embodiment of the storage system shown in FIG. 3.

FIGS. 6A and 6B show a safety locking system for the storage system.

FIGS. 7A and 7B show accessory mounting for the storage system.

FIG. 8 shows a view of a garage or storage space having a storage system.

FIG. 9 shows a simplified view of a house or other building having a storage system for storing items in an attic or upper floor.

FIG. 10 is a top view of an exemplary embodiment of an adjustable storage system.

FIG. 11 is a view of the length side the adjustable storage system shown in FIG. 10.

FIG. 12 is a view of the width side the adjustable storage system shown in FIG. 10.

FIG. 13 is a top view of an alternative embodiment of an adjustable storage system.

FIG. 14 shows a bottom view of another embodiment of an adjustable storage system.

FIG. 15 shows a perspective cross-sectional view taken along section line XV-XV shown in FIG. 14.

FIG. 16 shows a perspective view of a single-point locking system.

FIG. 17 shows a second perspective view of the single-point locking system shown in FIG. 16.

FIGS. 18A-18D show plan views of various operating positions of components of the single-point locking system shown in FIGS. 16 and 17.

FIG. 19 shows a bottom view of the adjustable storage system shown in FIG. 14 illustrating an example of a cabling system that can be used to raise and lower the platform.

FIG. 20 shows a front view of a cable block that is used with the cabling system shown in FIG. 19.

### DESCRIPTION OF THE PREFERRED EMBODIMENT

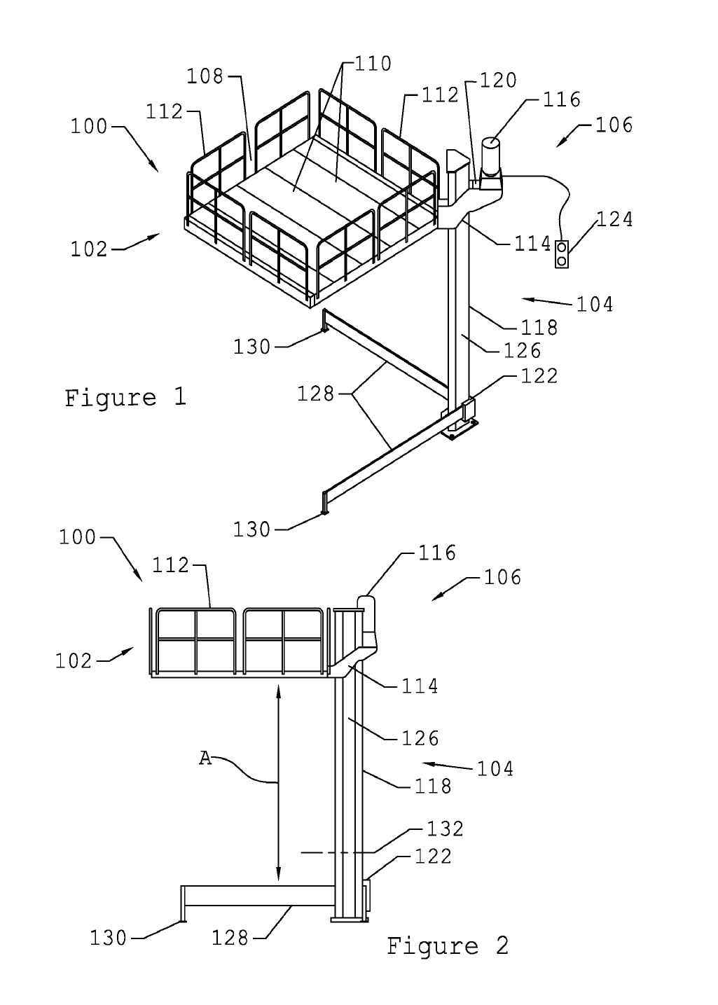

FIG. 1 shows a perspective view of an embodiment of a storage system 100. FIG. 2 shows a side view of the storage system 100. The storage system 100 includes a shelf assembly 102 supported by a support assembly 104. The support assembly 104 employs a drive system 106 that can be controlled by a user to adjust the height of the shelf assembly 102. Thus, the storage system 100 allows for a user to raise and lower the shelf assembly 102 in the directions indicated by the arrow A shown in FIG. 2. A user can lower the shelf assembly 102 to a position that is at or near ground level for easy access to stored items. While the shelf assembly 102 is at or near ground level, items can be more easily added and removed than if the shelf were still elevated. This provides for added convenience compared to prior static shelving systems. The shelf assembly 102 can then be raised so that stored items are stored in an elevated space. The space under the shelf assembly 102 is then available for use to store other items.

The shelf assembly 102 includes a storage platform 108 for supporting stored items. The storage platform 108 preferably includes a rigid and at least substantially planar upper surface. In some embodiments, the storage platform 108 can be adjustable such that the surface area of the storage platform 108 can vary. In some embodiments, the storage platform 108 can include one or more removable panels 110, for example metal, wood, plastic, rubber, or wire panels. The panels 110 can be solid or perforated. The panels 110 can be supported by an underlying support system, such as a rigid sub-flooring (which can also be formed of a number of panels) and/or a series of rigid cross-rails (not shown). In such embodiments, the panels 110 can be removable so as to leave an opening in the storage platform 108 when removed. The opening can then be aligned with objects or other obstructions so that the storage platform 108 can be lowered without a collision. In some embodiments, the panels 110 can be configured with raised or depressed regions for serving as wheel guides, for example for assisting with backing a trailer onto the storage platform 108.

In some embodiments, the shelf assembly 102 can include one or more guard rails 112, which can provide lateral support for stored items. At least some of the guard rails 112 are preferably removable or otherwise adapted to be moved out of the way, e.g., swing open like a gate, while items are being added and removed from the shelf assembly 102.

The shelf assembly 102 is supported by a carriage assembly 114, which in turn is supported by the support assembly 104 and the drive system 106. The carriage assembly 114 can be raised and lowered by the drive system 106, which in turn causes the shelf assembly 102 to be raised and lowered.

The drive system 106 can include any suitable means for raising and lowering the shelf assembly 102. In the illustrated embodiment, the drive system 106 is a screw-drive type of system that includes a motor 116 and a threaded screw 118. When activated, the motor 116 can cause a drive nut (not shown) to rotate. The drive nut engages the threaded screw 118 such that, as the drive nut rotates, the drive nut travels up or down the threaded screw 118 depending on the direction of the drive nut's rotation. Note that some embodiments can include a clutch system that, under certain circumstances, can prevent the drive nut from rotating while the motor 116 is activated, for example if the carriage 114 reaches a travel limit or is for some other reason prevented from traveling, e.g., the path of the carriage assembly 114 or shelf assembly 102 is blocked.

Alternative embodiments of the drive system 106 can include other types of driving means, including hydraulic, pneumatic, and manual systems.

The drive system 106 includes a control panel 124 for use by an operator to control the raising and lowering of the shelf assembly 102. The control panel 124 can be in wired or wireless communication with other components of the drive system 106. Simpler embodiments of the control panel 124 can simply include user controls for raising and lowering the storage platform 108. More complex embodiments of the control panel 124 can include such things as a numeric keypad, a qwerty keyboard, and a display, for example an LED or LCD display, and in some embodiments the display can provide touch-screen controls. In some embodiments, the drive system 106 can include wireless networking capabilities to allow for remote control of the drive system 106 via a wireless network, e.g., Wi-Fi, Bluetooth, or other such connection with a computer, personal digital assistant (PDA), or other such device.

The drive system 106 can also include means for setting pre-selected travel limits or stop positions. In the illustrated embodiment, the drive system includes an adjustable upper stop 120 and an adjustable lower stop 122, which can each be independently positioned at desired locations along the threaded screw 118. The upper stop 120 is for limiting the upward travel of the carriage assembly 114 and the lower stop 122 is for limiting the downward travel of the carriage assembly 114. The upper and lower stops 120 and 122 are threaded so as to engage the threads of the threaded screw 118. This allows the position of the upper and lower stops 120 and 122 to be adjusted by rotating the stop 120, 122 until it arrives at the desired position. The upper and lower stops 120 and 122 can include a locking means, such as a lock nut or set screw, for securing them in position.

In some embodiments, the drive system 106 can include means for setting pre-selected stop positions, such as the stop position indicated by the broken line 132 in FIG. 2. The stop position 132 might be a particularly desirable elevation for the shelf assembly 102 for any of a number of different reasons. For example, the user might have a flat-bed trailer and equipment that is occasionally transferred between the bed of the trailer and the storage platform 108. The user may then desire for the drive system 106 to “remember” the stop position 132 so that the user can more easily raise or lower the storage platform 108 to the stop position 132. The drive system 106 can include a memory, or have access to a memory, that stores information representative of stop positions such as stop position 132.

There are a number of different ways in which the support assembly 104 can be constructed and arranged. The embodiment of the support assembly 104 shown in FIGS. 1 and 2 provides a cantilever type of support. The support assembly 104 includes an upright 126 formed of a rigid material that extends vertically somewhat parallel to the threaded screw 118. Base bars 128 are also constructed of a rigid material and are connected to the upright 126 at or near ground level. A foot 130 is connected to each base bar 128 at or near a far end of the base bar 128 from the upright 126. In some embodiments each foot 130 can be independently adjusted to aid in leveling the storage system 100.

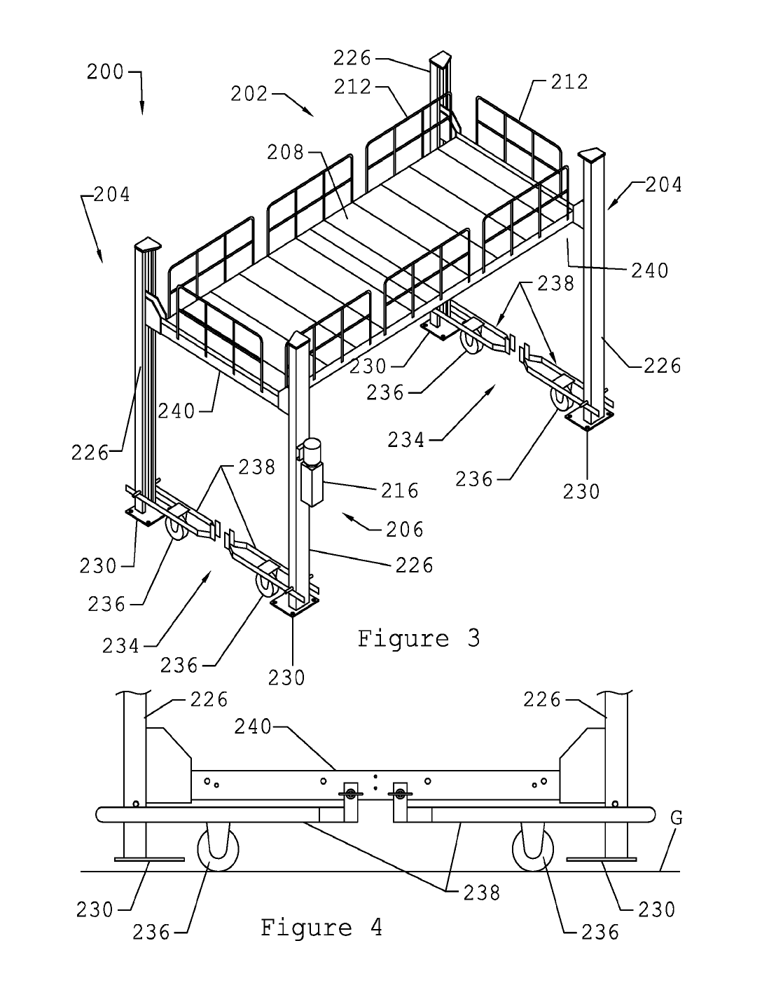

FIG. 3 shows a perspective view of a storage system 200. Compared to the storage system 100, the storage system 200 includes an alternative four-post support assembly 204 and an alternative hydraulic drive system 206. Alternative embodiments can include a four-post support assembly and a four-post screw drive system that operates like the drive system 106.

In FIG. 3, the shelf assembly 202 is similar to the shelf assembly 102, a difference being that the shelf assembly 202 is adapted to be supported at all four corners as shown in FIG. 3 rather than at a single corner as shown in FIG. 1. The shelf assembly 202 includes a storage platform 208, for which the description above of the storage platform 108 applies equally. The shelf assembly 202 can also include panels 210 and guard rails 212. The description above of the panels 110 applies equally to the panels 210, and the description above of the guard rails 112 applies equally to the guard rails 212.

The support assembly 204 includes a plurality of uprights 226 which serve as support posts for the shelf assembly 202. Each of the uprights 226 is connected to a respective base plate 230. The base plates 230 allow for mounting the storage system 200 in place.

A caster kit 234 allows the storage system 200 to be mobile. The caster kit 234 includes a plurality of casters 236. Each of the casters 236 is mounted on a respective caster bracket 238. When the shelf assembly 202 is raised, for example as shown in FIG. 3, the storage system 200 rests on the base plates 230 rather than on the casters 236 so that the storage system 200 cannot be moved using the casters 236.

FIG. 4 shows a side view of a portion of storage system 200 wherein the shelf assembly 202 has been lowered and the storage system 200 is supported by the casters 236. The cross-rails 240 are supported by the caster brackets 238 and the base plates 230 are lifted from the ground G. In order to arrive at this configuration, the user can lower the shelf assembly 202 from a raised position, such as the raised position shown in FIG. 3, until the cross-rails 240 arrive at the caster brackets 238. If the user then continues to try to lower the shelf assembly 202, since the shelf assembly 202 is supported by the caster brackets 238, which are in turn supported on the casters 236, the shelf assembly 202 will cease to lower and, instead, the uprights 226 will raise off of the ground G, resulting in the configuration shown in FIG. 4. In this configuration, the storage system 200 is supported by the casters 236 and can be moved using the casters 236. In some embodiments removable hardware can be used to secure the caster kit 234 to the storage system 200. For example, pins can be used to secure the caster brackets 238 to the cross-rails 240 while in the configuration shown in FIG. 4.

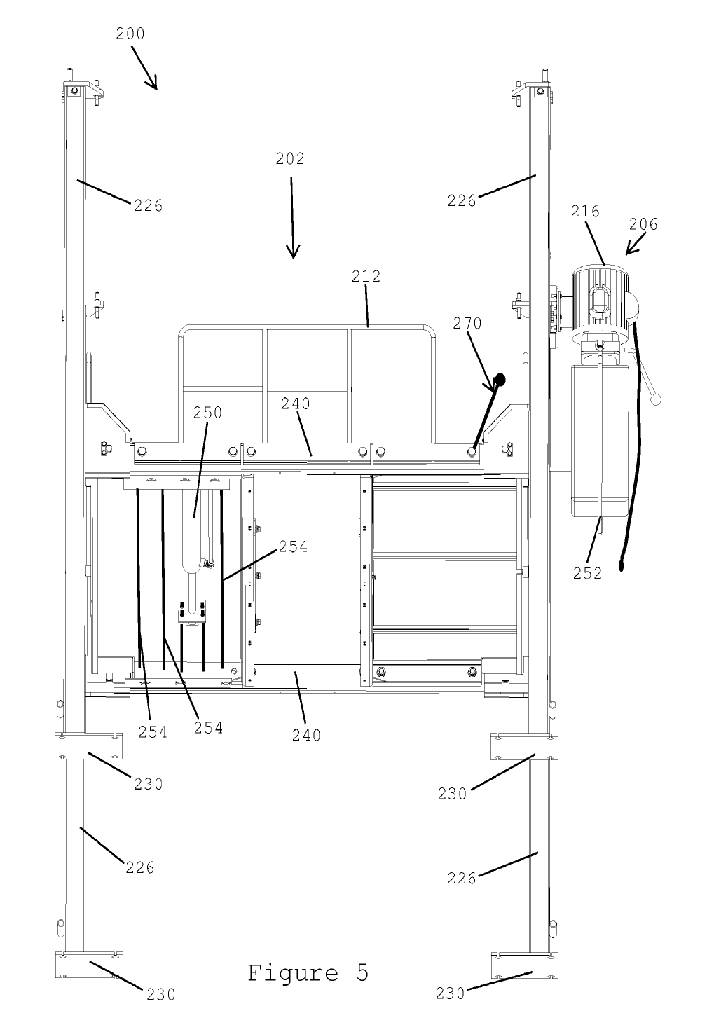

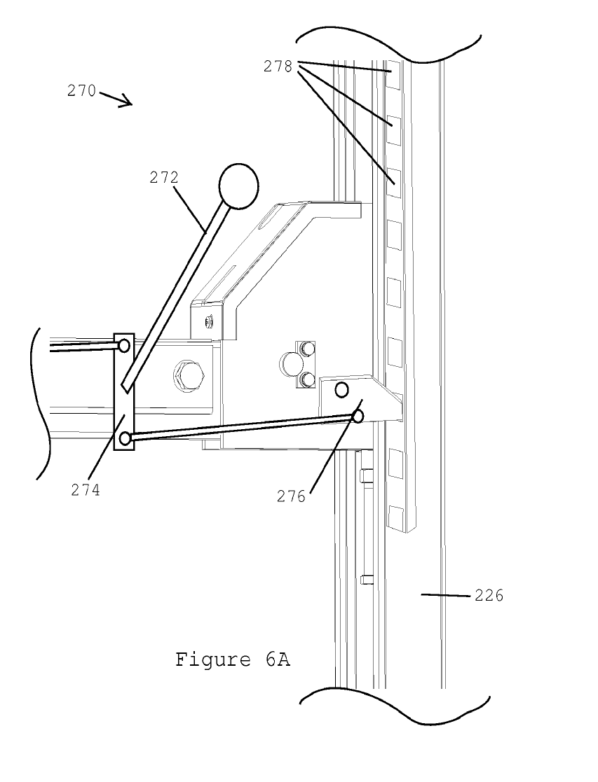

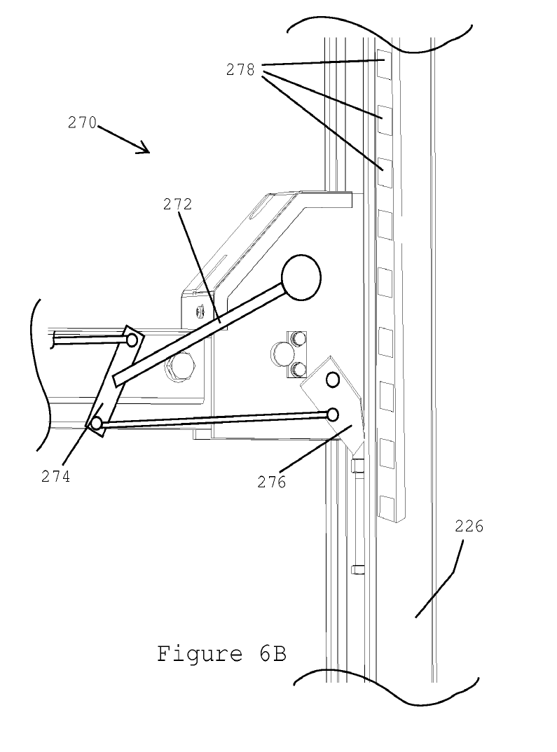

FIG. 5 shows a second perspective view of the storage system 200. The view shown in FIG. 5 includes a view of additional components of an embodiment of the drive system 206. The view shown in FIG. 5 also shows an embodiment of a safety locking system 270, which will is described below in connection with FIGS. 6A and 6B.

In FIG. 5, the drive system 206 includes a pump motor 216. The pump motor 216 is connected to a hydraulic cylinder 250 via a hose 252 that allows for fluid transfer between the pump 216 and the hydraulic cylinder 250. The pump motor 216 can be controlled by a user to extend and retract the ram of the hydraulic cylinder 250. Cables 254 or the like can be extended from the end of the ram of the hydraulic cylinder 250 to the uprights 226 such that the extension and retraction of the hydraulic cylinder 250 causes the raising and lowering of the shelf assembly.

FIGS. 6A and 6B show an embodiment of the safety locking system 270. In FIG. 6A the safety locking system 270 is engaged, and in FIG. 6B the safety locking system 270 is released. The safety locking system 270 can be engaged when the shelf assembly 202 is raised, for example as shown in FIG. 3, in order to provide additional support for the shelf assembly 202. The safety locking system 270 includes a control arm 272, linkage 274, and a safety bar 276. A user can move the control arm 272 between the position shown in FIG. 6A and the position shown in FIG. 6B. The control arm 272 controls the position of the safety bar 276 via the linkage 274. This allows the safety bar 276 to be moved in and out of one of the notches 278 in the upright 226. Several notches 278 are provided in the upright 226 to allow for the safety locking system 270 to support the shelf assembly 202 at several different heights.

The safety locking system 270 can be provided for any number of the four uprights 226. For example, some embodiments of the storage system 200 can include four of the safety locking systems 270, where one is associated with each of the four uprights 226. As another example, some embodiments of the storage system 200 can include two of the safety locking systems 270, where one is associated with each of the two diagonally opposing uprights 226.

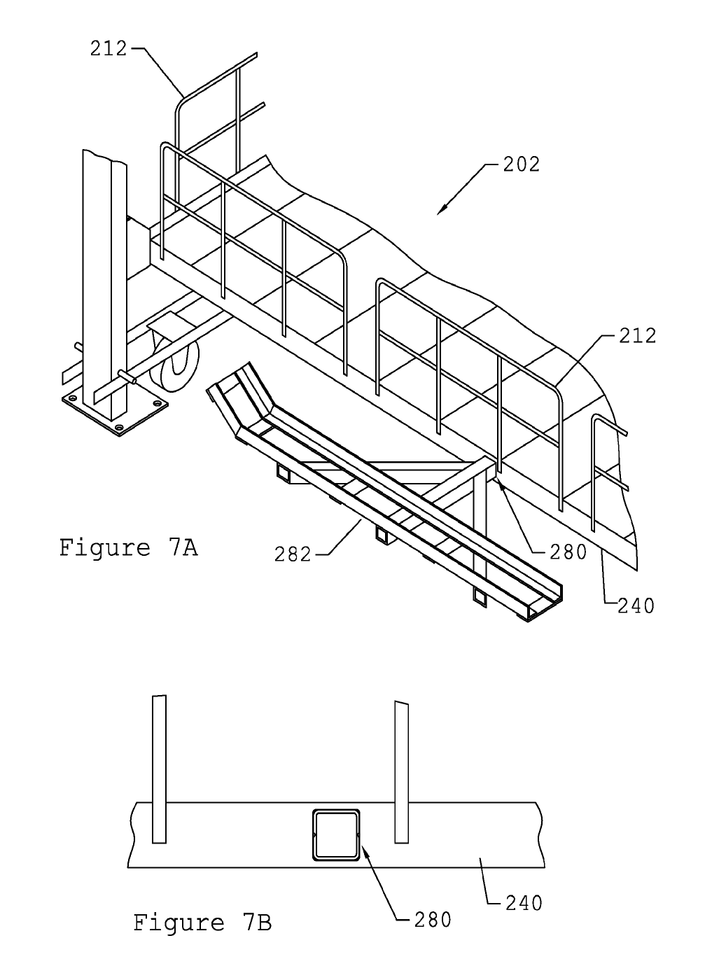

FIG. 7A shows a partial perspective view of the shelf assembly 202 with an optional accessory receiver 280 to which an accessory 282 can be removably mounted. FIG. 7B shows a view of the receiver 280 without the accessory 282 installed. The receiver 280 is provided in cross rail 240 of the shelf assembly 202. The receiver 280 in this embodiment is a standard two-inch receiver configured to receive hitch-mountable carriers such as motorcycle, bicycle, or cargo carriers. For example, the accessory 282 shown in FIG. 7A is a hitch-mountable motorcycle carrier that can be removably attached to the receiver 280 using pins (not shown). This not only allows for such automotive hitch-mountable accessories to be conveniently stored on the shelf assembly 202, but also allows for storage of whatever items the accessory is designed to support. For example, in the embodiment shown in FIG. 7A, the accessory 282 is a hitch-mountable motorcycle carrier, which when mounted as shown allows for storage of a motorcycle on the storage system 200.

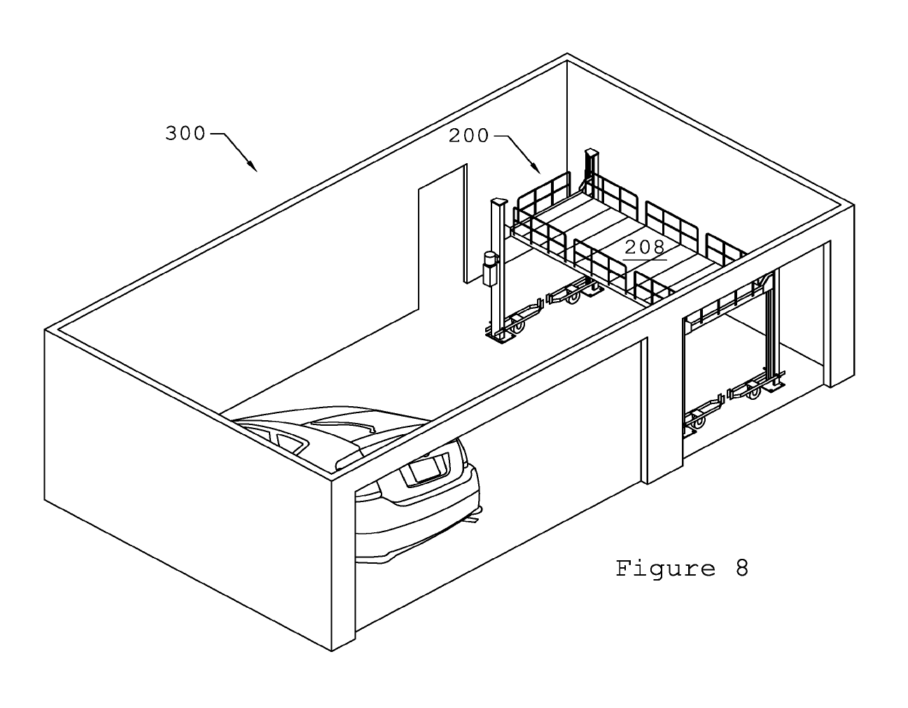

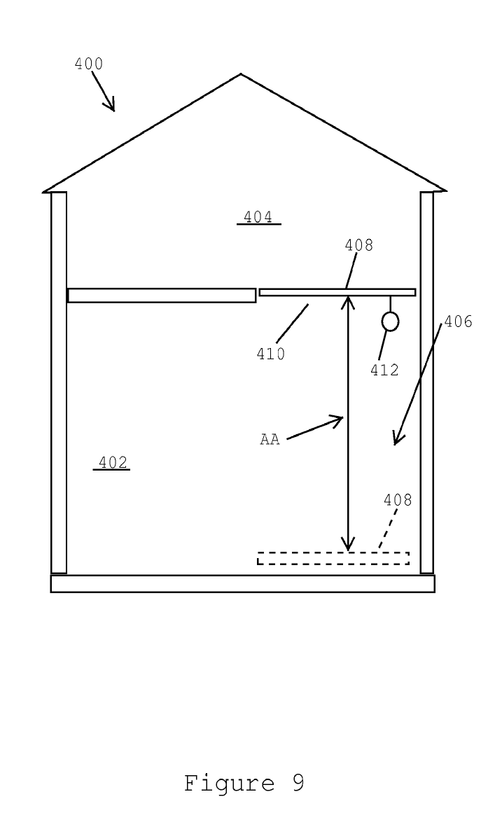

FIG. 8 shows an example of how the storage system 200 can be used in a storage space such as a garage 300. The storage system 200 provides storage that is capable of storing heavy and cumbersome items on site in air space that would otherwise be unoccupied. The storage platform 208 can elevate heavy items that cannot be safely placed onto stationary shelving by a person or persons, especially without the aid of a forklift.

The storage system 100 or 200 can be used to provide attic storage or to move items from one floor to another. For example, FIG. 9 shows a simplified view of a house or other building 400 that includes a garage 402, an attic 404 above the garage, and a storage system 406 that includes a storage platform 408. The storage system 406 can include components of the embodiments described herein. The storage platform 408 can be moved by a user between a raised position (shown in solid lines) and a lowered position (shown in broken lines) in the directions shown by arrow AA. In the raised position, items stored on the storage platform 408 will be stored in the attic 404. The storage system 406 allows for convenient access to these items. Items stored in the attic 404 on the storage platform 408 can be accessed by simply lowering the storage platform 408 into the garage 402. In some embodiments, the underside 410 of the storage platform 408 can be textured, painted, or otherwise adapted to blend in with the ceiling in the garage 402. In some embodiments, the underside 410 of the storage platform 408 can be provided with a light fixture 412 for illuminating the area under the storage platform 408. In some embodiments, the underside 410 of the storage platform 408 can include hardware (not shown) to allow for hanging items, for example bicycle hooks for hanging bicycles or a second storage platform.

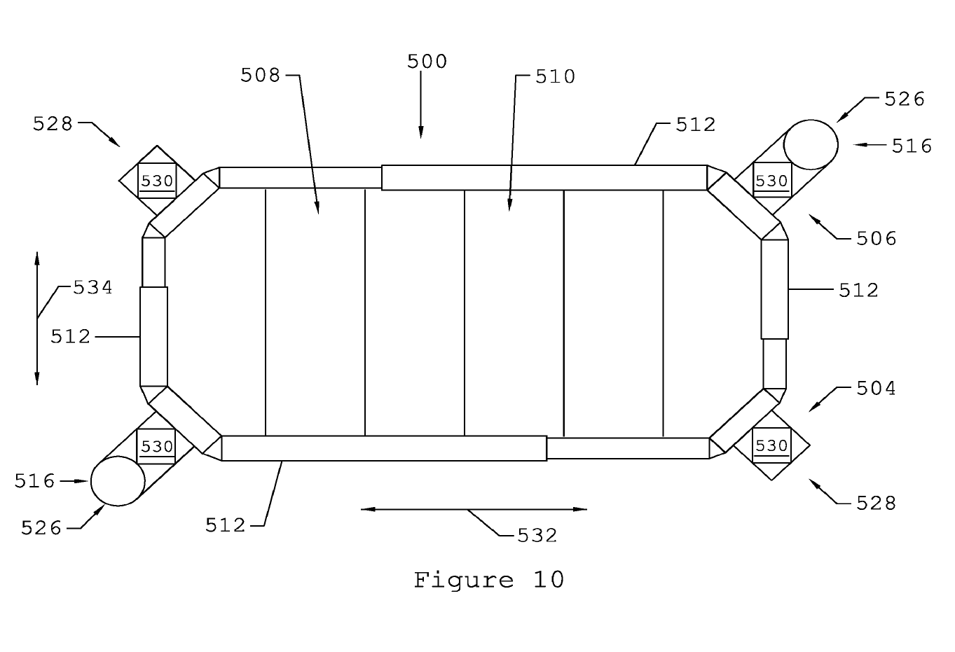

FIGS. 10 through 12 show an exemplary embodiment of an adjustable storage system. FIG. 10 shows a top view of adjustable storage system 500. Compared to storage system 200 in FIG. 3, storage system 500 includes four-post support assembly 504 and a four-post screw drive system 506 that operates like the drive system 106. Alternative embodiments can include a four-post support assembly and a hydraulic drive system that operates like the drive system 206.

In FIG. 10, the shelf assembly 502 is similar to the shelf assembly 202. The shelf assembly 502 includes a storage platform 508, for which the description above of the storage platform 108 applies equally. The shelf assembly 502 can also include panels 510 and side rails 512. The description above of the panels 110 applies equally to the panels 510.

Side rails 512 comprise a series of gradually smaller cross-tubes, such that each section of smaller cross-tube may retract into or expand from a larger section of cross-tube. Holes are drilled at certain points in side rails 512 to secure the cross-tube at various lengths. As each smaller cross-tube slides into the large cross-tube, shelf assembly 502 is adjustable in both length and width, as indicated by bidirectional arrows 532 and 534.

In an exemplary embodiment, opposing sets of side rails 512 go from smaller to larger sized cross-tubing in different directions. Thus, if the cross-tubing of side rails 512 on one side of shelf assembly 502 goes from a smaller to larger size in a left to right direction, the side rail directly opposite will go from smaller to larger sized cross-tubing in a right to left direction.

In order to reduce the length of shelf assembly 502, one or more panels 510 are removed from storage platform 508 and then side rails 512 are compressed length-wise, the smaller cross-tube sections retracting inside the larger cross-tube sections, for closing the gap created by removing the one or more panels 510. Increasing the length of shelf assembly 502 is accomplished by completing the steps in the reverse order.

In order to reduce the width of shelf assembly 502, all the panels 510 are removed from storage platform 508. Side rails 512 are compressed width-wise, the smaller cross-tube sections extending from within the larger cross-tube sections, until the desired shorter width is reached. New panels 510 corresponding to the adjusted, shorter width are then replaced in shelf assembly 502. Increasing the width of shelf assembly 502 is accomplished by completing the steps in the reverse order.

The support assembly 504 includes a plurality of uprights 526 and 528. Each of the uprights 526 and 528 are connected to a respective base plate 530. The base plates 530 allow for mounting the storage system 500 in place. Uprights 526 are diagonally opposite each other and each is connected to a motor 516. The two motors 516 are wired to be controlled by a single control switch. The two motors 516 are configured so as to raise and lower shelf assembly 502 in sync. Uprights 528 are diagonally opposite each other and do not have a motor connected to them.

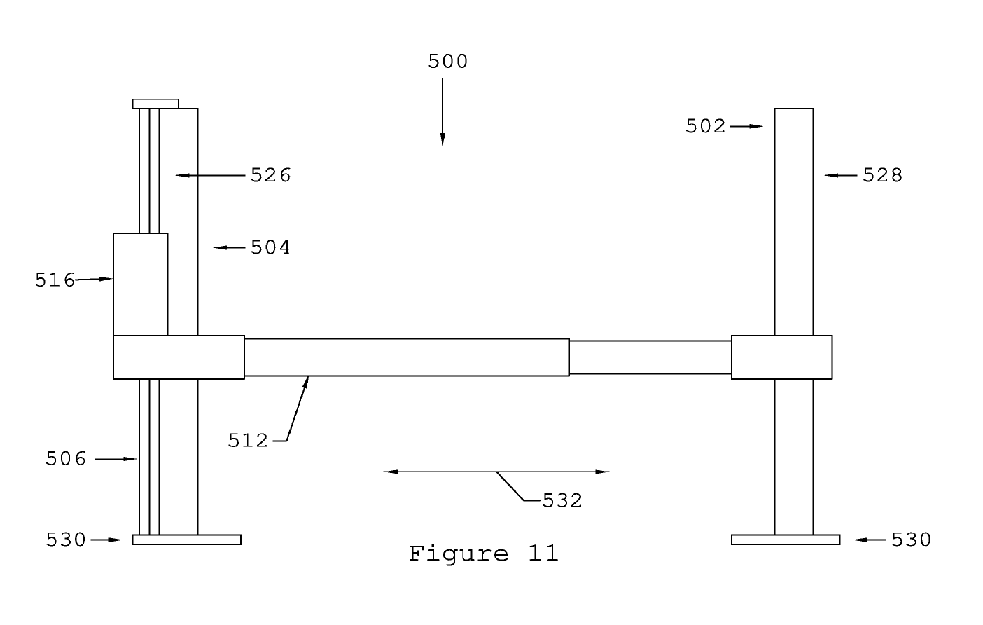

FIG. 11 shows a side view of the length side of the adjustable storage system 500 in FIG. 10. FIG. 11 illustrates how storage system 500 is adjustable in length. As can be seen from the side view, side rail 512 is comprised of various sections of cross-tubing, going from a smaller diameter to a larger diameter. The smaller diameter cross-tube is sized to fit inside the next larger size of cross-tube. Holes are drilled at certain points in side rails 512 to secure the cross-tube at various lengths. This allows for storage system 500 to be adjusted in the directions indicated by arrow 532.

Storage system 500 adjusting in the directions of arrow 532 assumes that upright 526 is anchored to the floor through base plate 530 and that system 500 expands away from the anchored upright 526. Alternatively, upright 528 may be secured to the ground while upright 526 is not anchored to the floor. In such a case storage system 500 would expand away from upright 528.

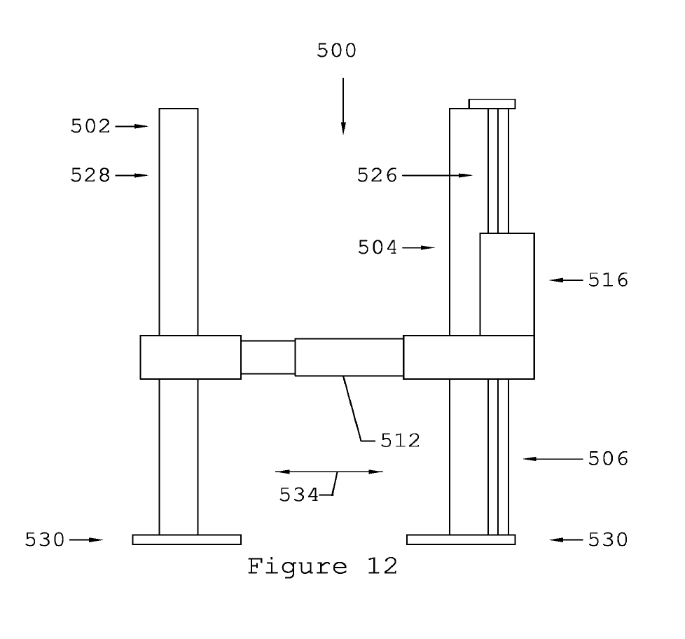

FIG. 12 shows a side view of the width side of the adjustable storage system 500 in FIG. 10. FIG. 12 illustrates how storage system 500 is adjustable in width. As can be seen from the side view, side rail 512 is comprised of various sections of cross-tubing, going from a smaller diameter to a larger diameter. The smaller diameter cross-tube is sized to fit inside the next larger size of cross-tube. Holes are drilled at certain points in side rails 512 to secure the cross-tube at various lengths. This allows from storage system 500 to be adjusted in the directions indicated by arrow 532.

Storage system 500 adjusting in the directions of arrow 534 assumes that upright 526 is anchored to the floor through base plate 530 and that system 500 expands away from the anchored upright 526. Alternatively, upright 528 may be secured to the ground while upright 526 is not anchored to the floor. In such a case storage system 500 would expand away from the anchored upright 528.

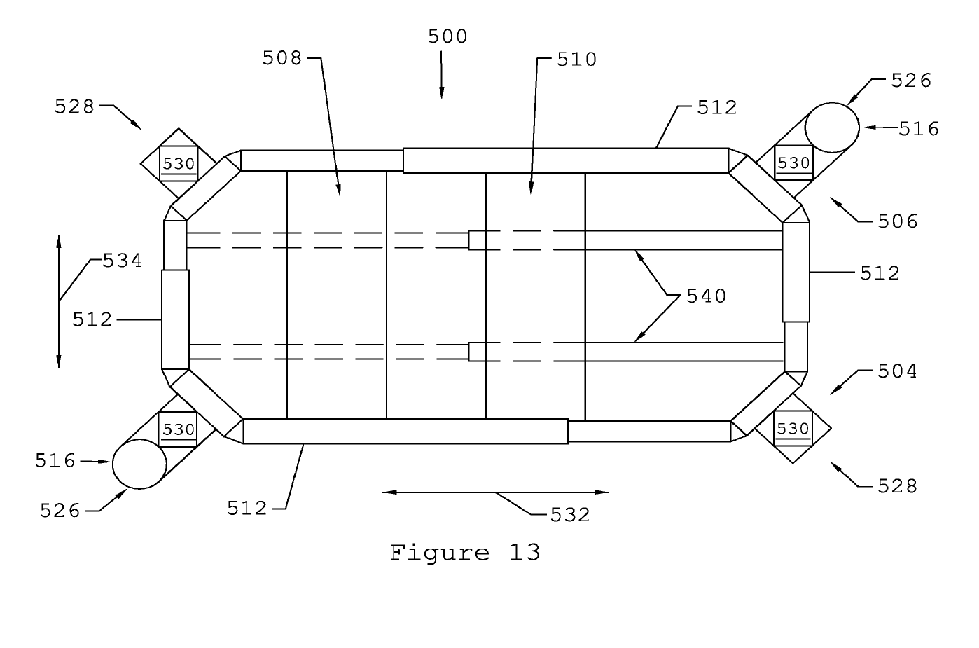

FIG. 13 shows a top view of an alternate embodiment of adjustable storage system 500 in FIG. 10. Compared to storage system 500 in FIG. 10, storage system 600 includes all the same elements plus support beams 540. In the depicted embodiment, two support beams 540 are shown. However, in alternative embodiments other numbers of support beams may be used, such as one, three, four, or more. Support beams are similar in construction to side rails 512 in that support beams 540 are constructed of beams of multiple sections that are of gradually smaller sizes, such that the smaller sections may retract into the larger sections and expand from the larger sections when the length of shelf assembly 502 is adjusted.

Support beams 540 are connected to side rails 512. Thus when the width of storage system 500 is reduced, support beams 540 are moved closer together. Thus, in an alternative embodiment, support beams 540 may be removed or attached to side rails 512 as the width of storage system 500 is reduced.

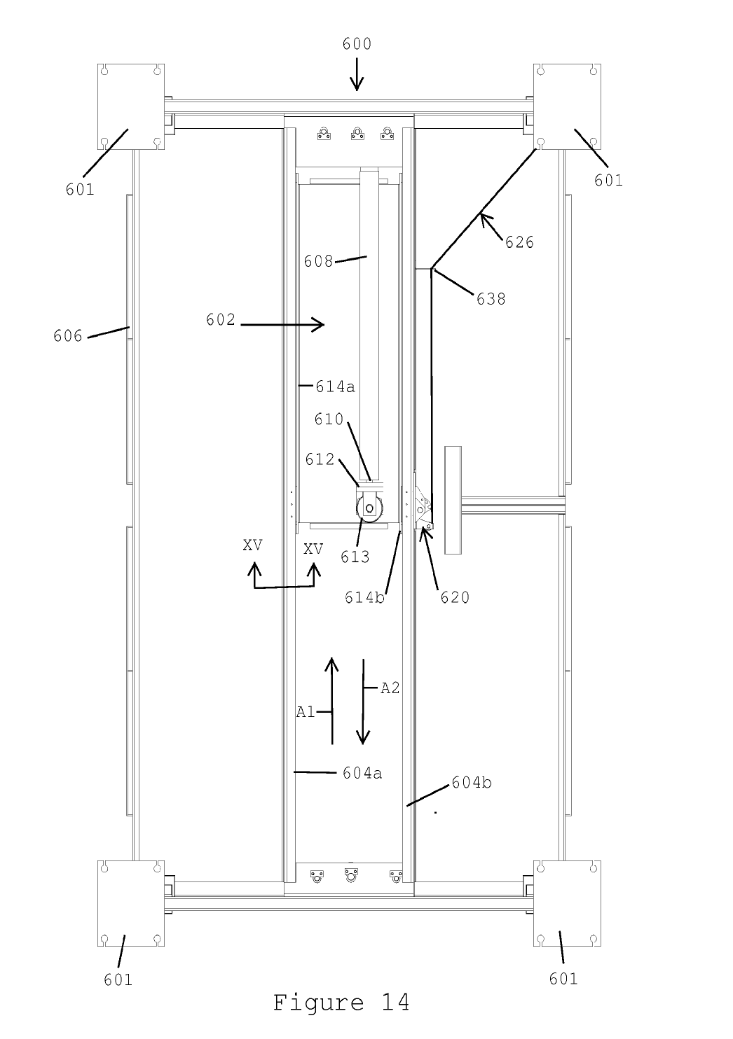

FIGS. 14-19 show an exemplary embodiment of a sliding single-point locking system for an adjustable storage system such as any of the storage systems described herein. FIG. 14 shows a bottom view of adjustable storage system 600. In this embodiment, the storage system 600 is similar to the storage system 200 shown in FIG. 3 and described above, except that the storage system 600 includes the sliding single-point locking system as described below. It should be noted, however, that the sliding single-point locking system can be used with any of the storage systems described herein.

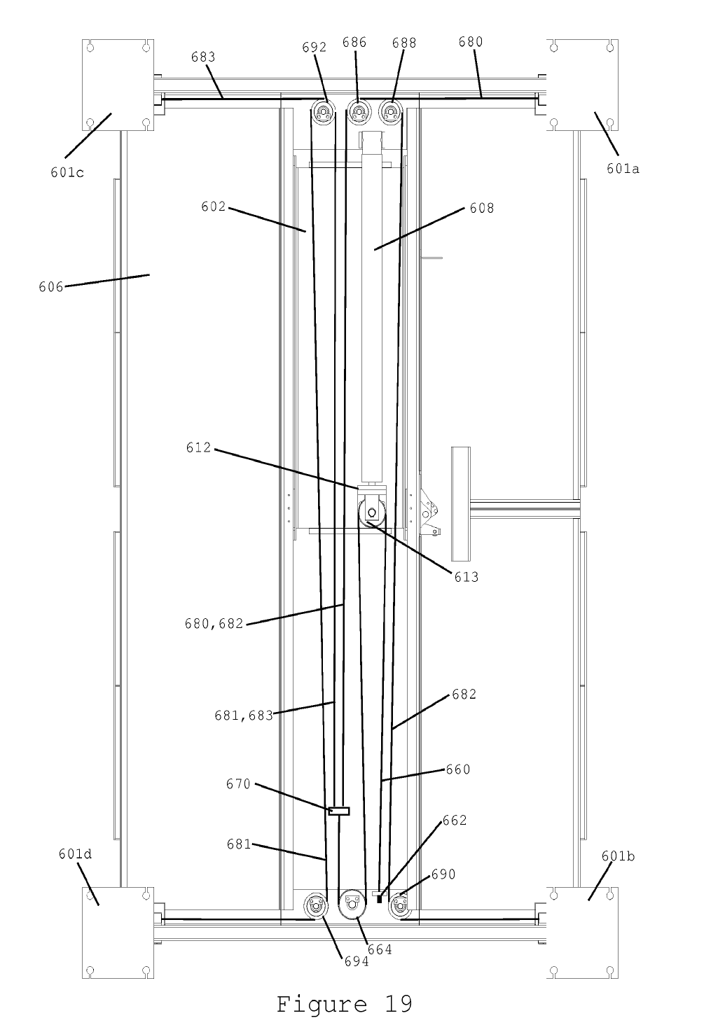

The storage system 600 is supported by one or more rigid uprights 601 and includes a sliding carriage 602. In preferred embodiments, the carriage 602 is formed of a rigid metal such as steel; however, in alternative embodiments other rigid materials can be used. The sliding carriage 602 is located between two C-channel support beams 604a and 604b on the bottom side of the storage platform 606. Like the storage system 200 described above, the storage system 600 includes a hydraulic cylinder 608 having a cylinder rod 610 that extends and retracts under the control of a user in order to adjust the height of the platform 606. The cylinder rod 610 is attached to the carriage 602 at bracket 612. Thus, as the cylinder rod 610 extends, the carriage 602 moves in the direction indicated by arrow A1, and as the cylinder rod 610 retracts, the carriage 602 moves in the direction indicated by arrow A2. In the present embodiment, a cable-carrier pulley 613 is attached to the cylinder rod 610 and the carriage 602 via the bracket 612. Cables or the like can be extended from the end of the cylinder rod 610 to the uprights 601 such that the extension and retraction of the cylinder 608 causes the raising and lowering of the storage platform 606. For example, in the present embodiment, the storage platform 606 is lowered as the cylinder rod 610 extends and the carriage 602 moves in direction A1, and the storage platform 606 is raised as the cylinder rod 610 retracts and the carriage 602 moves in direction A2. More details concerning the arrangement of such cables is described below in connection with FIG. 19.

Still referring to FIG. 14, the sliding carriage 602 has support posts 614a and 614b that are carried by respective C-channel support beams 604a and 604b, which provide a tracking path for the carriage 602 to move axially in the same direction as the cylinder rod 610 (directions A1 and A2). The support posts 614a and 614b can be attached to the carriage 602 by various attachment means, for example by welding or fasteners such as bolts.

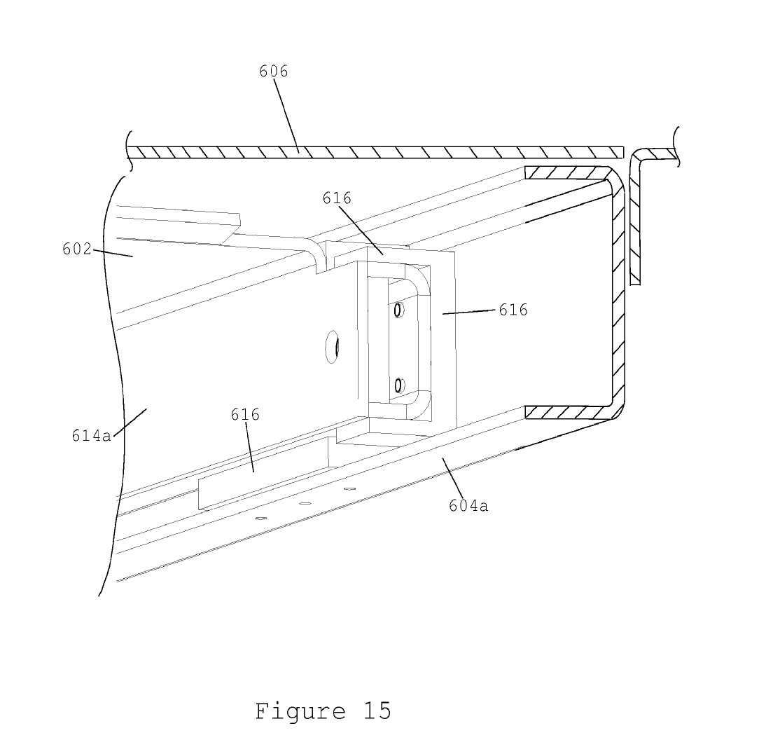

FIG. 15 shows a perspective cross-sectional view taken along section line XV-XV shown in FIG. 14. The view in FIG. 15 shows an enlarged view of the support post 614a. As shown in FIG. 15, slide blocks 616 are provided between the support post 614a and the C-channel support beam 604a. Slide blocks 616 can be attached to the support post 614a or the C-channel support beam 604. Slide blocks 616 are formed to fit inside of the C-channel support beam 604a. The slide blocks 616 are preferably formed of a material that provides for minimal friction as the carriage 602 slides back and forth. For example, the slide blocks 616 can comprise Ultra-High Molecular Weight (UHMW) Polyethylene that is resistant to wear and has a low coefficient of friction. Note that additional slide blocks 616 are similarly attached to the opposite support post 614b and are formed to fit inside of the C-channel support beam 604b. In some embodiments, any number of slide blocks 616 can be disposed between the support posts 614 and respective C-channel support beams 604. In alternative embodiments, a single slide block 616 can be disposed between each support post 614 and its respective C-channel support beam 604 and extend the length of, or a substantial portion of the length of, each C-channel support beam 604.

Referring back to FIG. 14, the storage system 600 also includes a single-point locking system 620, which can lock the position of the carriage 602 at any one of a number of stop positions. Since the cable-carrier pulley 613 is fixed relative to the carriage 602, the locking system 620 also provides a positive stop for the storage platform 606 in several positions and prevents the storage platform 606 from lowering when the carriage 602 is locked in place by the locking system 620. In preferred embodiments, the single-point locking system 620 can be unlocked by a user using a single cable, handle, or the like, allowing the carriage 602 to move and thereby allow the storage platform 606 to be lowered. The single-point locking system 620 is more fully described below.

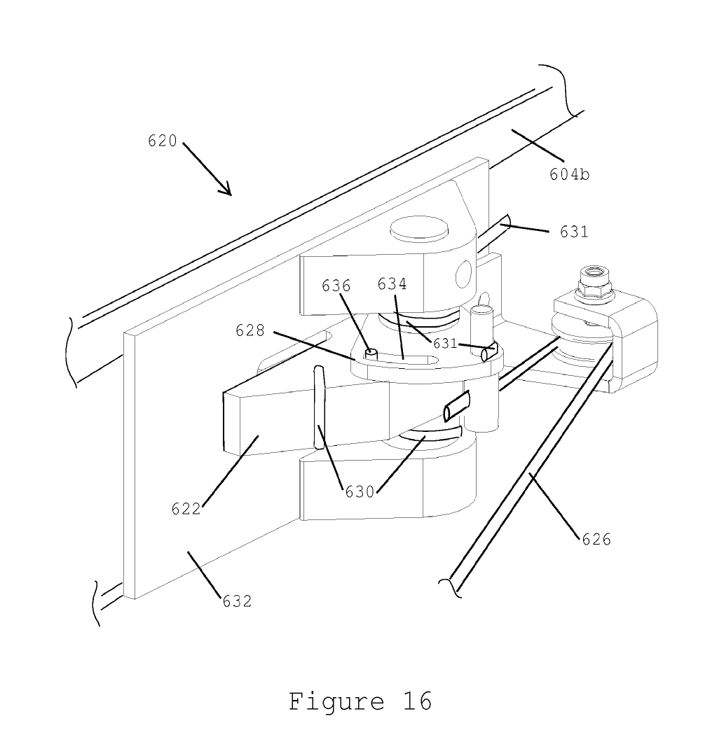

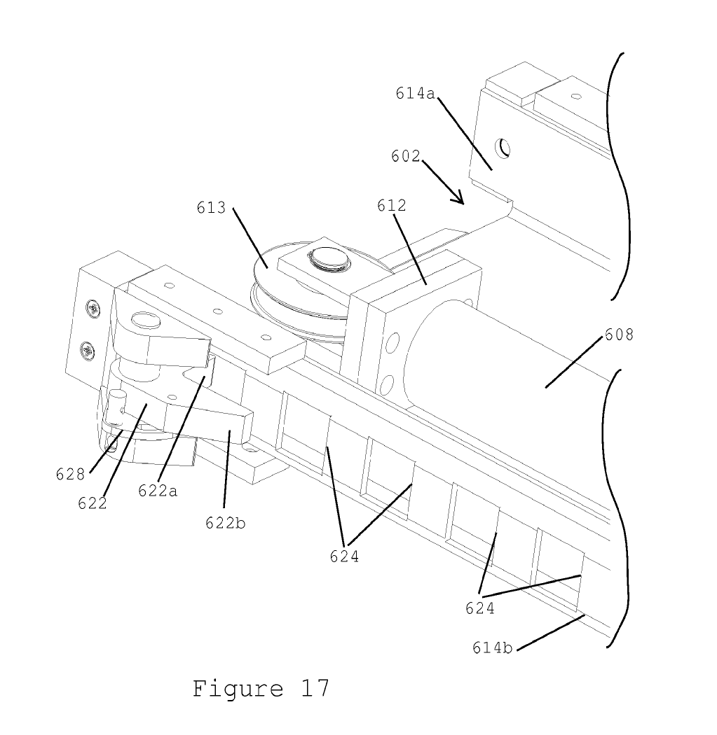

FIG. 16 shows a perspective view of the single-point locking system 620, and FIG. 17 shows a second perspective view of portions of the single-point locking system 620 and the carriage 602 where several elements of the storage system 600, including the C-channel support beam 604a, have not been shown for purposes of clarity. The locking system 620 is attached to a side of the C-channel support beam 604b opposite the sliding carriage 602. The locking system 620 has a movable locking cam 622, which includes a first cam lobe 622a and a second cam lobe 622b. The first cam lobe 622a engages the support post 614b in that it is sized and shaped such that it fits into the holes 624 of the support post 614b. In the illustrated embodiment, the holes 624 are rectangular; however, the holes 624 can have other shapes in alternative embodiments. Also, in alternative embodiments, notches, ridges, or other various surface structures can be used in place of holes. The locking system 620 also comprises a release cable 626, cam plate 628, a cam spring 630, a cam-plate spring 631, and a stop plate 632.

The locking cam 622 will allow free movement of the carriage 602 as the storage platform 606 rises. When the desired height for the storage platform 606 is reached, the operator releases hydraulic pressure from the power unit, which starts to lower the platform 606 until the first cam lobe 622a engages the surface of a hole 624 in the support beam 604a. This locks the platform 606 in position, providing a solid stop with zero hydraulic system pressure. When the operator is ready to lower the storage platform 606, the operator energizes the hydraulic power unit raising the platform 606 until the locking cam 622 can be pulled out of engagement with the support beam 604a. This is accomplished by use of a small sheathed cable 626, which has a first end that is attached to the locking cam 622 via a cam plate 628 and a second end that is attached to a handle, lever, or the like (not shown) in a position that is accessible to the operator. The operator can pull on the cable 626 (for example by pressing a lever or pulling a handle), thus withdrawing the first cam lobe 622a from the current hole 624 in which the first cam lobe 622a was disposed. The operator would then relieve hydraulic pressure from the cylinder 608 while continuing to pull on the cable 626, thereby holding the first cam lobe 622a away from the holes 624 in the support beam 604a so as to prevent the first cam lobe 622a from engaging the holes 624, and thus allowing the platform 606 to lower under the force of gravity. When the platform 606 is in the desired down position, the operator can release the cable 626, which would allow a spring 630 to pull the locking cam 622 back into the lockable position where the first cam lobe 622a is free to engage the holes 624. Thus, the single-point locking system 620 may be incorporated into the storage platform 600 in such a way that two hands are required for lower the platform 606, which improves the safety of the storage platform 600 since it helps insure that the operator is in the correct position and the operator's hands are not in a position where injury could occur.

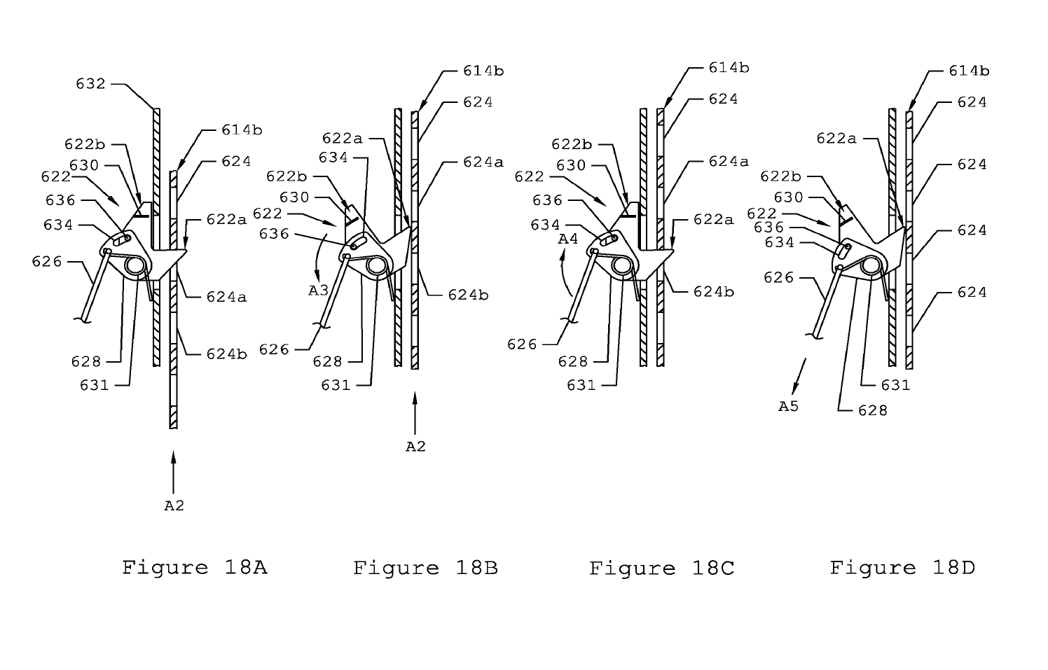

FIGS. 18A-18D show plan views of various operating positions of components of the single-point locking system 620. FIGS. 18A-18C show how the locking cam 622 engages each hole as the sliding carriage 602 moves in direction A2, thereby raising the platform 606. In FIG. 18A, the first cam lobe 622a is disposed in a hole 624a. In this position, the first cam lobe 622a is disposed in the hole 624a and the second cam lobe 622b is flush against a stop plate 632. In this position, the sliding carriage 602 is prevented from moving in the direction opposite A2 (i.e., direction A1 shown in FIG. 14) because the stop plate 632 prevents the second cam lobe 622b from continuing to move in a clockwise direction as illustrated. As the platform 606 is raised, the sliding carriage 602 moves in direction A2 from the position shown in FIG. 18A to the position shown in FIG. 18B, where the locking cam has rotated counter-clockwise to the position shown in FIG. 18B. As the sliding carriage 602 moves from the position shown in FIG. 18A to the position shown in FIG. 18B, the edge of hole 624a pushes against the first cam lobe 622a causing the cam 622 to rotate counter-clockwise (as indicated by arrow A3) and the first cam lobe 622a to move out of the hole 624a. As the platform continues to rise, the cam 622 and support post 614b move from the position shown in FIG. 18B to the position shown in FIG. 18C. In FIG. 18C, the first cam lobe 622a has become aligned with the next hole 624b. As a result, and due to the spring 630 urging the cam 622 to rotate in a clockwise direction, the cam 622 has rotated clockwise (as indicated by arrow A4) until the second cam lobe 622b is once again flush against the stop plate 632 and the first cam lobe 622a is disposed in the hole 624b. Once again, the cam 622 is in position to lock the platform 606 in such a way that the platform 606 cannot be lowered. From the position shown in FIG. 18C, the platform 606 can continue to rise, in which case the locking system 620 will continue to cycle through the positions shown in FIGS. 18A-18C.

Note that the cam plate 628 remains substantially motionless in FIGS. 18A-18C. As the cam 622 pivots back and forth between the illustrated positions, the cam plate 628 is held in position due to the cam plate spring 631 and the cable 626. The cam plate spring 631 urges the cam plate 628 to rotate in a clockwise direction (arrow A4 in FIG. 18C). However, the cable 626 prevents the cam plate 628 from rotating any further clockwise from the position of the cam plate 628 shown in FIGS. 18A-18C. Referring momentarily back to FIG. 14, the cable 626 is extends through a bracket 638. The cable 626 is fitted with a cable stop at the bracket 638 that prevents any additional length of cable 626 from passing through the bracket 638 towards the cam plate 628. As a result, the portion of the cable 626 between the cam plate 628 and the bracket 638 is under tension due to the force of the spring 631 and the cam plate 628 is held in position. The cam plate 628 is provided with a slot 634. A roller pin 636 which is fixed to the cam 622 is positioned in the slot 634 and is sized and positioned so as to be free to move back and forth in the slot 634 as the cam 622 pivots. This arrangement allows the cam 622 to pivot back and forth while the cam plate 628 remains fixed in place. This prevents the cable 626 from becoming tangle or sustaining excess wear that could otherwise occur if the attachment point of the cable 626 were pivoting with the cam 622.

As discussed above, in order to lower the platform 606, the cable 626 must be pulled in order to release the locking system 620. FIG. 18D shows the result of the cable 626 being pulled. In FIG. 18D, the cable 626 is being pulled in the direction indicated by arrow A5. This causes the cam plate 628 to rotate in a counter-clockwise direction. As the cam plate 628 rotates, the edge of the slot 634 applies pressure to the roller pin 636, which is fixed to the cam 622. As a result, the counter-clockwise rotation of the cam plate 628 also causes a counter-clockwise rotation of the cam 622. As the cam rotates counter-clockwise, the first cam lobe 622a is withdrawn from whichever of the holes 624 it was disposed until reaching the position shown in FIG. 18D. In this position, since the cam 622 is being held such that the first cam lobe 622a is away from the holes 624, the carriage 602 is now free to move in either direction A1 or A2, thus allowing the platform to be raised or lowered.

Turning next to FIG. 19, an example of a cabling system is shown that can be used to raise the platform 606 as the cylinder rod 610 is retracted and lower the platform 606 as the cylinder rod 610 is extended. The cabling system is a 2:1 ratio system, meaning that every foot of cylinder rod 610 travel gives 2 feet of vertical displacement of the platform 606. It should be appreciated that this is one of many cable arrangements that can be used to adjust the height of the platform 606 using the extending and retracting motion of the cylinder rod 610. A first cable 660 extends from tie-down point 662, around the carrier pulley 613, then around a first idler pulley 664, and terminates at block 670. The first cable 660 is fixed at one end thereof to the tie-down point 662 and fixed at the opposite end thereof to the block 670.

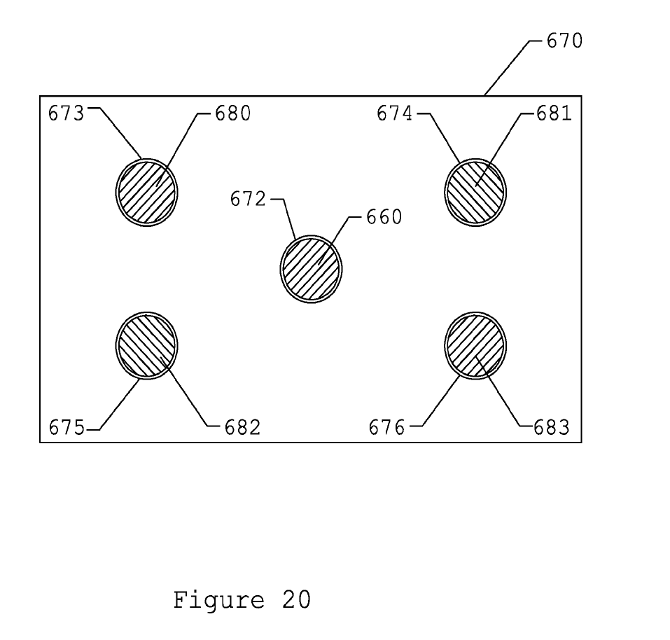

FIG. 20 shows a front view of the block 670. The block 670 has five apertures 672-676 which serve as connection points for respective cables 660 and 680-683. Note that alternative embodiments can include any type of connection means for attaching the cables 660 and 680-683 to the block.

Turning back to FIG. 19, four cables 680-683 extend from the side of the block 670 opposite the side of the block 670 to which the cable 660 extends. Each of the four cables 680-683 extends from the block 670 to the top of a respective one of the uprights 601. Cables 680 and 682 both extend from the block 670 to a second idler pulley 686 and then to a third idler pulley 688. From the third idler pulley 688, the cable 680 extends to the top of upright 601a, while the cable 682 extends to a fourth idler pulley 690 and then to the top of upright 601b. Cables 681 and 683 both extend from the block 670 to a fifth idler pulley 692. From the fifth idler pulley 692, the cable 683 extends to the top of upright 601c, while the cable 681 extends to a sixth idler pulley 694 and then to the top of upright 601d.

The foregoing description has been presented for purposes of illustration and description and is not intended to be exhaustive or limited to the invention in the form disclosed. Many modifications and variations will be apparent to those of ordinary skill in the art.

We claim:

1. A storage system comprising:
a support assembly;
a shelf assembly supported by the support assembly, the shelf assembly comprising:
a storage platform;
panels that are removable from the storage platform; and
guard rails bordering the storage platform, wherein the guard rails are removably connected to the storage platform; and
a drive system controllable by a user to raise and lower the shelf assembly.

2. The storage system of claim 1, wherein the support assembly provides a cantilever type of support for the shelf assembly.

3. The storage system of claim 1, wherein the support assembly comprises a plurality of support posts.

4. The storage system of claim 1, wherein the support assembly comprises a plurality of retractable casters.

5. The storage system of claim 1, further comprising an accessory receiver in the storage platform.

6. The storage system of claim 1, wherein the drive system comprises means for limiting travel of the shelf assembly.

7. The storage system of claim 1, wherein the drive system means for setting one or more pre-selected stop positions.

8. The storage system of claim 1, wherein the drive system comprises a screw-drive system.

9. The storage system of claim 1, wherein the drive system comprises a hydraulic system.

10. The storage system of claim 9, wherein at least a portion of the hydraulic system is supported by and travels with the storage platform.

11. The storage system of claim 1, further comprising a control panel in communication with the drive system, the control panel adapted for use by a user for controlling the raising and lowering of the shelf assembly.

12. The storage system of claim 1, further comprising a safety locking system for preventing the shelf assembly from lowering when engaged and allowing the shelf assembly to be lowered when disengaged.

13. An adjustable storage system comprising:
a support assembly;
a shelf assembly supported by the support assembly, the shelf assembly comprising:
a storage platform;
panels that are removable from the storage platform; and
side rails bordering the storage platform, connected to the storage platform, the side rails formed of a plurality of sections, wherein each section of the plurality of sections is retractable into another section of the plurality of sections; and
a drive system controllable by a user to raise and lower the shelf assembly.

14. The adjustable storage system of claim 13, further comprising at least one support beam connected to at least one side rail, wherein the at least one support beam is formed of a plurality of sections, wherein each section of the plurality of sections is retractable into another section of the plurality of sections.

15. The adjustable storage system of claim 13, wherein the storage platform has a length dimension and width dimension, and wherein at least one of the length and width dimensions is adjustable.

16. The adjustable storage system of claim 15, wherein both the length and width dimensions are adjustable.

17. A locking system for selectively preventing the lowering of a platform, the locking system comprising:
a cam configured to pivot between a locking position and an unlocking position, wherein the cam prevents the platform from lowering when the cam is in the locking position;
a cam spring for urging the cam towards the locking position; and
a cam plate configured to engage the cam for urging the cam towards the unlocking position,
wherein the cam plate is configured to maintain its position during at least a portion of the pivot of the cam between the locking position and the unlocking position.

18. The locking system of claim 17, further comprising a release cable attached to the cam plate for allowing a user to move the cam from the locking position to the unlocking position.

19. The locking system of claim 18, further comprising a cam-plate spring, wherein the cam-plate spring urges the cam plate towards a first direction and the release cable urges the cam plate towards a second direction when the user controls the release cable to unlock the locking system.

20. The locking system of claim 17, wherein the cam comprises a cam lobe for engaging a sliding member supported by the platform, wherein the sliding member moves in a first direction as the platform rises and moves in a second direction as the platform lowers, wherein the cam lobe engages the sliding member when the cam is in the locking position such that the sliding member is free to move in the first direction and is prevented from moving in the second direction.
